(19) United States
(12) Patent Application Publication
(10) Pub. No.: US 2014/0201061 A1
(43) Pub. Date: Jul. 17, 2014

(54) ON-LINE AUTOMATED LOAN SYSTEM

(71) Applicant: WONGA TECHNOLOGY LIMITED, Dublin (IE)

(72) Inventors: Nikola Sivacki, London (GB); Daniel Hegarty, London (GB); Gareth Griffith, London (GB)

(21) Appl. No.: 13/840,434

(22) Filed: Mar. 15, 2013

(30) Foreign Application Priority Data
Jan. 14, 2013 (GB) 1300650.7

(51) Int. Cl. G06Q 40/02

(52) U.S. Cl. CPC G06Q 40/025
USPC 705/38

(57) ABSTRACT

A computerized system for determining whether to provide a loan to a customer who would like to purchase goods from a website of a merchant. The computerized system includes at least one processor, at least one memory, and at least one program stored in at least one of the memories. The at least one program causes the computerized system to respond to a receipt of a notification that the customer is browsing one or more pages of the website by crawling one or more pages of the website to determine the presence or absence of specified features on the pages and providing a decision as to whether or not to authorize a loan to the customer to purchase the goods from the merchant as a function of the presence or absence of the specified features.

### BACKGROUND OF THE INVENTION

This invention relates to methods and systems for verification of websites and other sources of data relating to an entity to improve lending decisions.

Online systems are increasingly being used in which a client device connects with a website system over a communication path, such as the Internet, and in which a third party software module forms part of the communication chain. An example of such an approach is a so called popup or plugin used in a Web browser to request data from a user and provide data to a remote system while the user interacts with a website server.

### SUMMARY OF THE INVENTION

An arrangement of this disclosure provides a lending system in which a browser may be redirected to a remote third party site of an online lender to exchange information and to request an online loan.

A computer implemented system for electronically processing a loan decision in which funds are to be provided to a merchant from a lending institution on behalf of a customer browsing a website is provided.

In one embodiment of the invention, the system comprises an input, connected to a communications network, for receiving a notification from a client device operated by the customer of the possibility of a transaction for the supply of goods from the merchant to the customer as a result of the client device browsing the merchant website, the notification being by the communications network. Such a notification may be by intercepting at the point of display of a price, a shopping basket or other indication of a possible purchase.

An output is connected to the communications network, for sending a request to the website of the merchant for one or more responses. The request may be for specific data, keywords or generally to aggregate data from the website of the merchant.

A loan module is coupled to the input and the output, and operable to process the notification, to generate the request to the website for one or more responses from pages within the website, to receive the responses, to process the responses to determine the presence or absence of specified content, and to provide a loan decision based at least in part on the presence or absence of the specified content. The loan decision may thereby take into account factors related to the identity of the user, but also factors related to a merchant website.

### BRIEF DESCRIPTION OF THE DRAWINGS

The invention will now be described in more detail by way of example with reference to the drawings, in which:

FIG. 1: is a functional diagram of the key components of a system embodying the invention;

FIG. 2: is an overview of the key functional components of the remote system component embodying the invention;

FIG. 3: is a flow diagram showing data collection using a crawling process;

FIG. 4: shows the process of accessing and parsing multiple external data sources concurrently;

FIG. 5: shows the aggregation of data from various sources; and

FIG. 6: shows the output module of FIG. 1.

### DETAILED DESCRIPTION OF THE PREFERRED EMBODIMENTS

The invention may be embodied in methods of operating client devices, methods of using a system involving a client device, client devices, modules within client devices and computer instructions for controlling operation of client devices. Client devices include personal computers, smart phones, tablet devices and other devices useable to access remote services. For ease of understanding, a system embodying the invention will be described first, followed by details of client devices and methods and message flows.

Overview

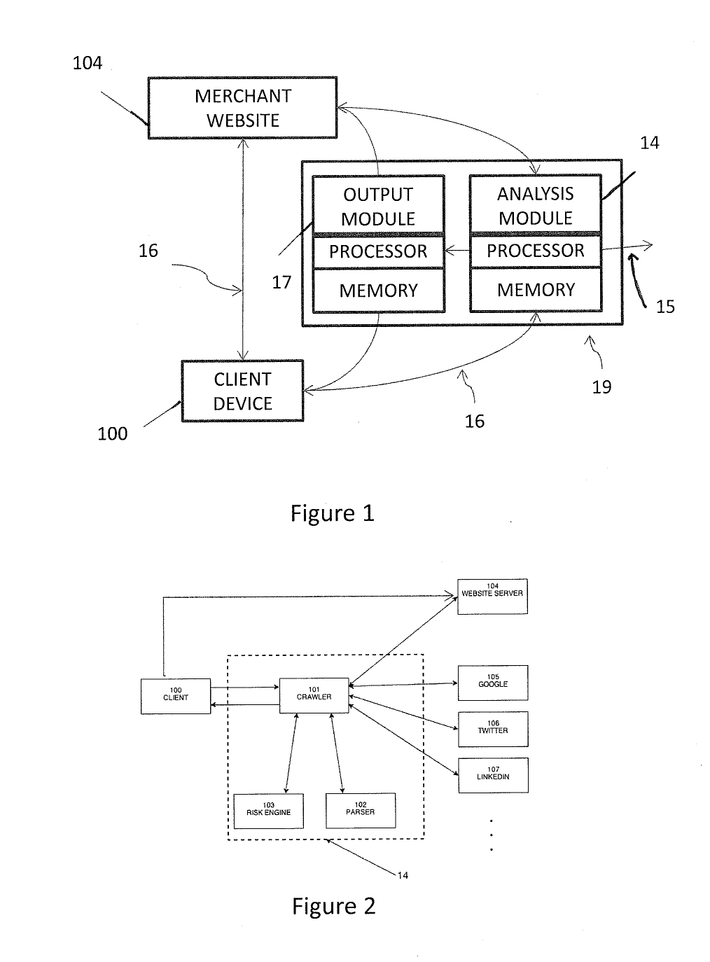

A system embodying the invention is shown in FIG. 1 and comprises a merchant website server 104 for providing web pages, one or more client devices 100 for receiving, presenting and interacting with the web pages and an analysis module 14 having a processor and memory which may be separate from both the website server and client devices for providing additional interaction with the client device. The client device connects with the merchant website 104 and analysis module 14 over a network 16, preferably the internet, but other technologies, whether wired or wireless, may be used in the communication path.

The analysis module 14 and output module 17 collectively provide an automated loan provider 19 of a lending institution. The analysis module 14 may be a self-contained system holding data available to client devices, but can also be a system that provides connectivity to other sources of data and functionality, shown by communication path 15. The analysis module 14 may thereby both retrieve data from other systems for provision to the client device, but may also provide instructions to other systems as a consequence of interaction with the client device. Preferably, the analysis module 14 is hosted at a remote system connected to the client device 100 by the internet. The analysis module 14 is coupled to an output module 17 having a processor and memory that can assert an output to the client device 100 over network 16.

In an alternative embodiment, the functionality provided by the analysis module and output module described below may be incorporated within the client device, in which case the analysis module may be a web browser plug-in, a Javascript process or dedicated functionality within the client device for retrieving data from a website, analysing and determining whether to proceed as described below. In such an embodiment, the client device determines whether a merchant website is acceptable and issues a requests for a loan from the lending institution as a result.

In a further alternative embodiment, the functionality of the analysis module, output module and client device may be provided at a computer system, such as a server, PC or cloud system, such that the computer system may connect to the website server and perform the retrieval and analysis steps described. One such arrangement may be a computer system for autonomously retrieving and checking a website, comprising a processor and memory arranged to undertake the checking steps to provide an output authorization message.

In the various possible embodiments described, the analysis module and output module may be implemented as processor and a memory storing program code for execution by the processor. The processor may be a general purpose processor or a dedicated processor.

The message flow in a system embodying the invention is shown in greater detail in FIG. 2. The flow shows the process when a client device 100 interacts with a merchant website 104, here shown as a website server 104, and the analysis module 14 intercepts and becomes part of the communication. The automated loan provider 19 may become part of the communication in a number of ways. In one embodiment, a user of the client device 100 browsing the merchant website 104 issues a request to the loan provider 19 for a loan for the purchase of goods from the merchant website. The request is transmitted from the client device 100 including one or more of the price, nature of goods, merchant name and the URL of the merchant website 104. In another embodiment, the client device 100 may automatically detect the presence of a product advertisement and transmit one or more of the price, nature of goods, merchant name and the URL of the merchant website to the loan provider 19. In another embodiment, the client device 100 may detect a shopping basket and provide one or more of the price, nature of goods, merchant name and the URL of the merchant website to the loan provider 19.

The analysis module 14 of the loan provider 19 accepts a request from a client application executing at the client device 100, containing the URL of the merchant website. This URL is accessed by a crawler module 101 of the analysis module 14. The client device 100 issuing the request initiates the process.

The crawler module 101 accepts the URL and company name in the request and proceeds on to “crawling” the website referenced by the received URL and gathers various relevant data during the crawling, such as existence of SSL certificate, average read and open time for pages on the website and the actual content of accessed pages on the website. The term “crawling” is understood to mean a process of examining (typically be stepping through) selected links within a website to extract information which may then be analysed. The crawler module 101 sends content from the merchant website 104 to a parser 102, which extracts various features, such as the existence of certain keywords anywhere in the content (from a configurable keyword list). A configuration module holds configuration settings for the crawler and parser.

The automated loan provider 19 receives the request for a loan to purchase goods and uses the crawler 101 to extract information from the merchant website 104 which may be used as part of the decision to lend money for the purchase of goods. The decision process discussed later may thus take into account not just the amount to be borrowed, the identity of the user and so the ability to repay, but also the acceptability of the merchant website 104. In one embodiment, acceptability of the merchant website 104 may be determined by presence of keywords. In another embodiment acceptability may be determined by presence of data such as kite marks, well-formed HTML (i.e., one that conforms to the rules of Extendible Mark Up Language) or other indicators of a reputable merchant website.

The crawler 101 also accesses various third-party websites which may be queried using the company name and the responses from the websites are parsed in a manner specific to those websites. For example, a search engine 105 such as Google™ may be queried to obtain the number of websites indexed by Google referencing the website, generating an integer number. The existence of entries on Twitter™ 106 may be retrieved. In case of LinkedIn™ 107, the presence of the company on LinkedIn™ is checked (thus returning a binary feature of yes/no).

A Risk Engine 103 gathers all the features produced above and calculates a score which is used to determine the next steps in the process. The risk score may determine whether a loan should be offered for the purchase of the goods. For example, if it is determined that the website is deemed high risk, then the loan may be declined or an amount offered reduced.

Data Aggregation

The process of following links to pages selected according to a crawling process described later, or to another retrieval process, produces a set of pages that can be analyzed to determine whether the website as a whole is deemed safe for use by the system. If so, an output signal may be asserted to allow the device to continue with a process at the website. The retrieval of data from the website may include retrieving words, graphics, certificates and other indicators of authenticity. In particular, a list of keywords may be compared to words on the pages of the website visited. If such words are found anywhere on the visited pages then a “feature” is determined to be present. Similarly, the presence of items such as SLL certificates, kitemarks and the like may also indicate that corresponding features are present.

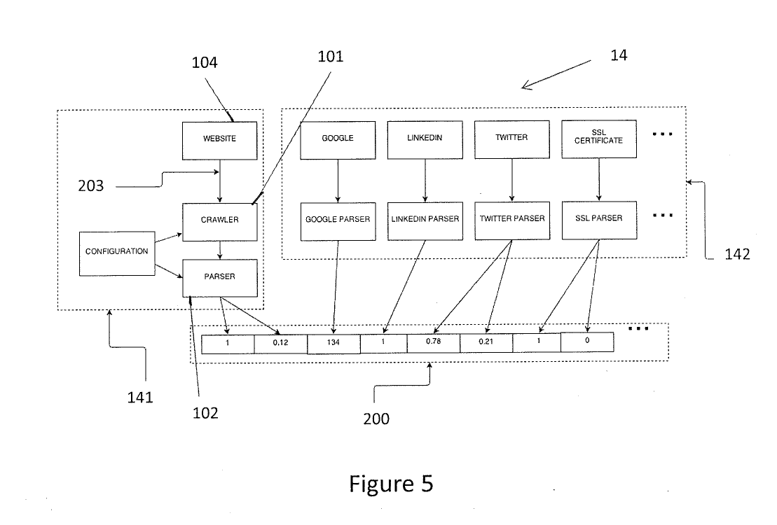

The existence of such features may be reduced to a value which, along with values for other features, may be handled as a multi-dimensional vector. FIG. 5 shows graphically how data from various sources may be reduced to such a vector. The analysis module 14 may be considered as two logical or physical parts, one part 141 for retrieving and processing the data from the merchant website 104 that the client device 100 is viewing, and a second part 142 for retrieving and processing the data from 3rd party web services, such as Google™, Twitter™, and so on.

Module 141 is responsible for crawling the merchant website producing features into the feature vector 200. The feature vector 200 represents a unified numerical vector that may be used by a statistical prediction module. The crawling of pages of the website may be performed in several threads 203, so that the retrieving of pages is performed concurrently. When the crawling of all pages is finished, module 141 proceeds to parse the data (producing the features for the unified feature vector 200). Module 142 crawls 3rd party websites and services, to produce the remaining of the features for the unified feature vector. This is also done by using several threads and is explained above. The unified feature vector 200 is ready to be processed once all stages in 141 and 142 have finished, so a synchronisation point exists here and is explained in more detail below.

The data aggregation related to a given merchant website 104, therefore comprises a combination of generating a scalar value from each of multiple sources and representing this as a vector, each dimension relating to a source. The individual scalar values may be calculated from matters such frequency of occurrence of certain words, values extracted such as validity of certificates and other such sources already mentioned. In this way, the complex question of determining the authenticity of a given merchant website may be reduced to a single vector for subsequent processing by a decision engine.

For example, when analysing a merchant website 104, the crawler 101 looks for certain keywords that are indicative of credibility or authenticity. For example, presence of words like ‘customer service’, ‘company history’, ‘our vision’, ‘our address’ live chat assistance' somewhere on the website, indicate credibility. The crawler 101 reads groups of such pre-defined words and outputs the corresponding feature having the value of ‘1’ if any of the words from a group is present on any page and ‘0’ otherwise. Some groups of words can have negative value as well, of course. This is all configurable and a set of files defining the word sets are administered together with the system and used to initialise the parser 102.

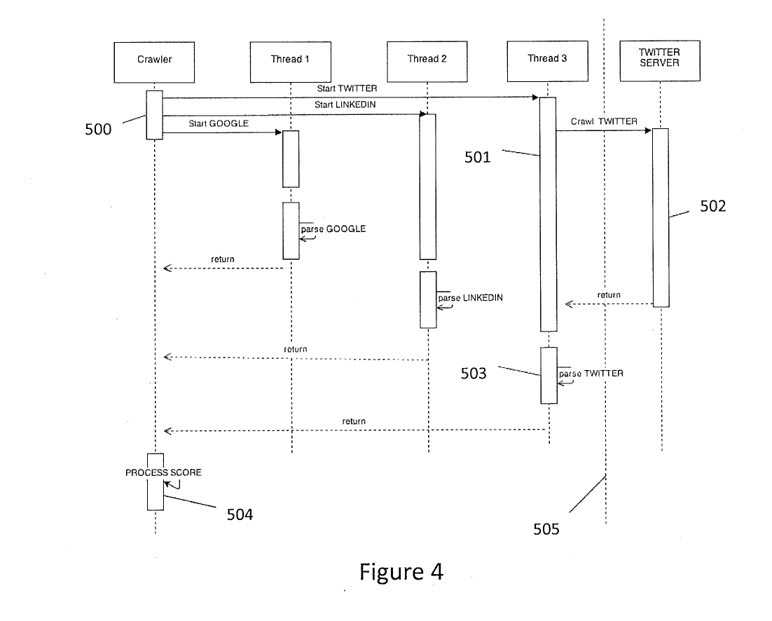

The parsing of external data can be very diverse and may include additional processing. For example, in the case of Twitter™, the processing may include calculating a sentiment score (a real number) of the mentions, using additional statistical packages in step 503. As another example, in the case of accessing domain registrar data, the returned absolute date of registration may be transformed into an integer offset noting the number of days from current date, so a date of one year ago would be transformed to an integer number 365. The key is that after stage 504 (FIG. 4) all these features are ready and aggregated into a single numerical vector, which itself is ready to be aggregated with internal features into a unified feature vector. An example of the aggregated feature vector, with both internal and external feature is given here:

| | | EXAM- | |
|---|---|---|---|
| | FEATURE | PLE | DESCRIPTION |
| 1 | ssl_redirect | 0 | HTTP redirects to |
| | | | HTTPS |
| 2 | ssl_expiry_days | 233 | days until ssl certificate |
| | | | expiry |
| 3 | time_open | 0.01 | avg time to access a page |
| 4 | time_read | 0.0084 | avg time to read a page |
| 5 | links_all | 394 | total links on crawled |
| | | | pages |
| 6 | links_local_ratio | 0.637 | fraction of local links |
| 7 | img_ratio | 0.0480 | fraction of image links |
| 8 | wc_seals | 0 | presence of SSL seals |
| 9 | wc_font | 1 | font change detected via |
| | | | css |
| 10 | domain_length | 18 | characters in domain |
| 11 | Ndigits | 0 | # of digits in domain |
| 12 | Credibility | 1 | Presence of credibility |
| | | | words |
| 13 | twitter_sentiment_avg | 0.870 | sentiment score of tweets |
| 14 | twitter_sentiment_std | 0.177 | sentiment std of tweets |
| 15 | Linkedin_present | 0 | company present on |
| | | | LinkedinTM |
| 16 | Google_inlinks | 306000 | # of 3rd party links |
| | | | pointing to site |
| 17 | whois_domain_in_email | 1 | domain present in whois |
| | | | contact email |
| 18 | whois_expiry_days | 421 | days until domain expiry |

The feature column is the name of the feature, the example column is a sample value produced by the system and the description column contains a description of the feature. The first twelve features above are internal features, produced by the directed crawler and the rest are external, produced by querying 3rd party services.

The derivation of each feature within the vector may be done in a variety of ways. Taking the example of word checking, there may be a “feature” for each group of words, such as the presence of words like ‘customer service’, ‘company history’, ‘our vision’, ‘our address’ or ‘live chat assistance’ somewhere on the website, which indicate a “credibility” as shown at location 12 of the above chart. This may be a binary value indicating the presence or absence of the selected words within the merchant website. Similar word checking lists of words may be used to derive other features covering aspects such as security, ease of use and so on.

Various features may be explicitly security related. The SSL related features at locations 1 and 2 of the above chart of the example vector show the existence of an HTTPS redirect on the home page of the site in question and the number of days to SSL certificate expiry.

Some features relate to the way in which the crawling process operates, such as features at locations 5 and 6 of the above chart in the example vector. These show the total number of links followed in the crawling process and the fraction of these deemed to be local links, rather than external links. This provides a measure of the size of the merchant website.

The aggregated feature vector thus provides a representation of apparently disparate sources of data related to a merchant website. The unified feature vector may be passed on to a separate output module that uses it to classify the merchant website into one of several predefined categories. This external module would contain an implementation of statistical learning model which would also be trained on this data. The fact that the vector is composed of numerical values (real numbers and integers) means that the data can be directly fed into such a statistical model with minimal modification. The output classifications from the model would be used as a signal to further influence the behaviour of the system (including potentially the client). The output module may be written in a variety of languages known to the skilled person and need not be discussed further.

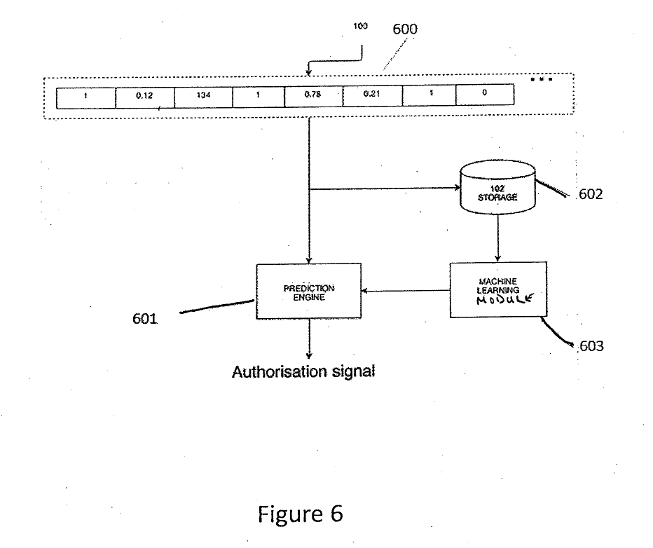

The output module 17 for generation of the authorization message or signal is shown in greater detail in FIG. 6. The feature vector, as previously described is received and provided to a prediction engine 601. This is the module that contains a prediction model, which has previously been trained in machine learning module 603. The vectors are also stored in the database 602 (in addition to being sent to the prediction engine), for training the model in the future.

Upon receiving the vector for a particular merchant website, the machine learning module feeds the vector into the previously trained model and produces the output score, which is used to further control the client device 100 (or an external system, which interacts with the client device), for example by indicating the availability of a loan for purchase for goods or authorizing the loan provider to provide payment to the merchant for the goods on behalf of the user.

Crawling Process

We have appreciated that the process of retrieving data (crawling) of websites needs to be completed in a limited amount of time, during the interaction of the user with a website. This imposes some limitations, namely in the amount of pages the crawler 101 can collect. Because of this, the crawler 101 needs to follow the links that are most likely to contain pages with content of likely interest when extracting internal features.

The crawler 101 should therefore follow links that are likely to contain interesting data such as target words. So, for a word set relating to a topic (say, customer service), the system stores another set of short words that are likely to be contained in the links pointing to pages that would contain the target words. This set could be, for example ‘contact’, ‘help’ and ‘customer’. Since the system cannot know in advance what page will contain the target words, this shorter word set is used to navigate through the links toward the pages that are likely to contain them, or other useful data. Using the words, certain links are scored higher, while some are filtered, so the short set directs the crawling process, trying to minimise the total number of pages requiring crawling before the target features are collected.

As described above, the embodying system may be used as part of a web interface, which generates a request that is handled by a web service and the request is inserted into a queue data structure. The system then polls this queue periodically and reads the request. After reading the request, it extracts the URL of the merchant website from it and extracts the main string from the URL, noting the company name. These two are used by the internal and external crawlers to crawl the merchant website and 3rd party services for parsing and generating features. The features are then passed on to a statistical model, here a Risk Engine 103, which outputs a score for that feature vector. A request is made to the service, with three parameters passed:

1. the URL of the company to be processed by the system

2. maximum number of pages to crawl (in the directed crawler)

3. maximum number of seconds for crawling to take

If the last two parameters are omitted, default values such as 50, 0 (no time limit) may be used. The webservice system responds with a message ‘Processing for companyname.co.uk started’ noting that the request is valid and that all request threads have been activated. After waiting for 15 seconds or more, calling get_score with the company URL as the argument returns the score calculated by the model.

As discussed above, for online loan systems and the like, processing time is an important factor. Accordingly, we have appreciated the need for directing and constraining the manner and time spent in the data retrieval “crawling” process on the target website. The process for following links and retrieving data from pages designated by those links, may be referred to as “crawling” as already mentioned.

The crawling process therefore needs to be constrained in some way, to balance the duration of crawling against the quality of crawled data and preferably to make this constraining tuneable. This is done by applying additional heuristics to the crawling process, whereby each link, which is considered for crawling, is scored for ‘quality’ and only top scoring links are followed. The crawling process ends once the predefined maximum number of pages is crawled or once the allocated time duration has been exceeded. Other ways of constraining the time period may be used in addition, or as alternatives.

Different scenarios might afford different durations of time for the crawling process before output of a signal derived from the crawled data is required, so the requested duration is an input parameter to the crawling process (as is the maximum number of links to crawl).

The crawler 101 does not know in advance how many pages it will end up crawling, nor what the total duration will be, since these depend on the structure of the website, but also on current parameters of the network, such as client device, bandwidth, latency, contention, etc. The requirement that the crawling process ends within N seconds with some acceptable loss in quality of retrieved data, means the system should adapt to potentially changing parameters of the network, without missing on the synchronisation point, which could be more costly than partially missing data.

The process operates by retrieving links on a given page, scoring those links, adding the links to a list and ranking in order of descending score. The link or links at the top of the list are then followed and links retrieved from the page defined by that link. The process of retrieving, scoring and adding to the same list is repeated for that page. In this way, a single list of links most likely to produce useful data is continually maintained and updated during the process. At any given point in time, the links scored at or near the top of the list are the ones to be followed next, irrespective of whether these were retrieved from a high level or low level page within the website structure.

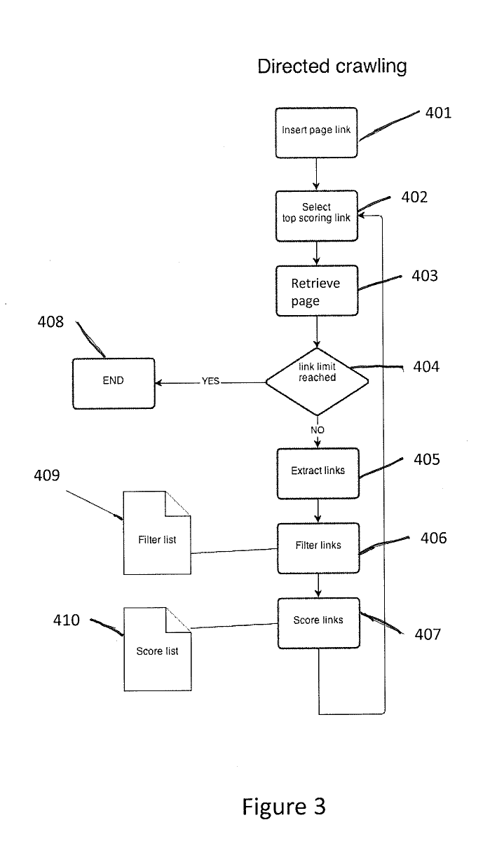

FIG. 3 shows the process for directed crawling. At step 401 the web page link is inserted to the crawling process. Links from the home page of the merchant website are then retrieved and scored and the top scoring link selected at step 402. The link scoring stage is key for leveraging the crawling time with crawling accuracy. The score for each link is calculated by matching keywords in the link description, increasing the score of the link if certain keywords are present and decreasing the score if others are present anywhere in the link. The list of words used for scoring is maintained in a score list 410.

The link scoring is, by way of example, presented in the following pseudocode.

```
LINK_URL=LINKS(i)
LINK_SCORE=0
for WORD in KEYWORDS do
  if WORD exists in LINK_URL then
  LINK_SCORE = LINK_SCORE + SCORES(WORD)
end
If (LINK_SCORE > THRESHOLD) then
  NEW_LINKS = CRAWL_LINK(LINK_URL)
  LINKS.ADD(NEW_LINKS)
end
```

The quality of the keywords selected impacts the crawling process. Having a better quality set of keywords, which direct the crawling process, allows for shorter duration of crawling (since better quality links are being followed and desired data is likely to be reached sooner). Together with tuning the score threshold for acceptable links, the keyword set in the score list 410 forms a configurable set of parameters that are tuned to meet the requests for the maximum amount of time allowed for crawling.

The set of keywords may be formed either by applying insight of what substrings are probably contained in the links of interest, or they may be formed by applying an algorithm, which is given a set of good links and it extracts substrings that tend to occur in them. The implementation of the crawling process preferably involves crawling each link in a separate thread, to maximize concurrency. The process thus continues by crawling the web page at step 403 until the link limit passed as a parameter is reached at step 404 and terminates at step 408, or continues to extract the links on the page at step 405, filter the links at step 406 based on a filter list 409 and then score the links at step 407. The process thus follows links from each page in parallel based on the top scoring link on each page. Several of these processes are executed concurrently and they synchronise after parsing when their outputs are aggregated into the unified feature vector as previously described.

After each link is crawled, the system time is consulted to establish whether the allocated duration for the crawling has been exceeded. If so, the crawling does not proceed and the crawled links are not scored for the next iteration. The time granularity of crawling corresponds to the time it takes to crawl an individual page (which is unknown in advance), after which the check is performed, so each thread would need to know when to stop crawling, not to exceed the time limit. This is achieved by each thread maintaining an average amount of time needed to crawl previous pages. Each thread contains the data of when it would need to finish and a comparison is made between this time limit, the current time and the average time required to crawl a page. If the remaining available time (after a links had just been crawled) is less than the average time needed for crawling, the crawling process ends. This way, although not guaranteeing the time of crawling to be less than requested, the system gives the statistical expectation is of that being the case. An example of this might be that given two links, the crawler needs to decide in which order to crawl them (prioritise), since there might not be time to crawl the second one:
http://www.site.com/contactus.php
http://www.site.com/faq.php

and the link keywords configuration contains the following keywords and scores.
where:1
address:1
contact:2
faq:1
help:3

The crawler process will score the first link with score 2 (having found the substring ‘contact’ in it) and the second link with score 1 (having found the substring It will therefore choose to crawl the first link first.

Multiple threads or processes may be used for the process of analysing the website as well as for retrieving data from other sources. To achieve this a main thread is provided to coordinate one or more sub-threads. The additional crawling threads are started by the main thread, which requires these additional threads to finish before it proceeds with aggregating their outputs into a unified feature vector. Each of the started threads receives a link to crawl and outputs the links extracted from the crawled page into the central list, administered by the main thread. As each of the threads produces a set of links, they are all scored and entered into the main list, from which the main thread retrieves the top scoring links (among all the links in the list) and passes them to the started threads. The centralized administration of the list by the main thread is provided to guarantee aggregation of the results from the threads and consistent following only of top scoring links during the crawling process.

FIG. 4 shows the process for retrieving data related to the website in question from other sources. The figure explains the process of accessing and parsing multiple external data sources concurrently. The figure separates the functions performed within the remote service (left of interface 505) and on 3rd party servers (right of interface 505). For conciseness, the figure provides examples of only three threads on the left side of line 105, but other external sources of data would be explained in the same way. Similarly, only one example of a 3rd party server process is provided (Twitter™ server—502), but additional servers would be explained in the same way. The system starts with starting jobs in several threads at the same time—one job for each external service accessed at step 500. Taking the example on the figure of Twitter™, the thread processing that request 501 initiates an external request to the Twitter search service 502 querying for the mentioning of the company within Twitter™. The service returns all mentions and the calling thread within the system 503 proceeds to parse and process the response to generate the required features.

At the synchronisation point 504, the main thread waits until all request threads have completed processing and then combines the results of their parsing into the unified feature vector as described above. After this, the feature vector can be passed on to other parts of the system as an output signal.

1. A computerized system for making a decision as to whether to provide a loan to a customer who would like to purchase goods from a website of a merchant, the computerized system comprising at least one processor, at least one memory and at least one program stored in at least one of the memories, the at least one program, when executed on one or more of the processors, causing the computerized system to respond to the receipt of a notification that the customer is browsing one or more pages of the website by:
crawling one or more pages of the website to determine the presence or absence of specified features on the pages; and
providing a decision as to whether or not to authorize a loan to the customer to purchase goods from the merchant as a function of the presence or absence of the specified features.

2. The computerized system of claim 1, wherein the computerized system also authorizes payment to the merchant in the event the loan is authorized and the customer purchases goods from the website.

3. The computerized system of claim 1, wherein the specified features includes the presence or absence of specified words on at least one of the web pages of the website.

4. The computerized system of claim 3, wherein the specified words provide an indication of whether the website is a website of a reputable merchant.

5. The computerized system of claim 3, wherein the specific words are stored on a configurable list.

6. The computerized system of claim 3, wherein the specific words include one or more of the following phrases: “customer service”, “company history”, “our vision” or “live chat”.

7. The computerized system of claim 1, wherein the specified features include features of the website which provide an indication of whether the website is a website of a reputable merchant.

8. The computerized system of claim 7, wherein the specified features include one or more of the following: a kitemark or a certificate.

9. The computerized system of claim 7, wherein the specified features include the presence of an HTML that closely follows the rules of Extendable Mark Up Language.

10. The computerized system of claim 1, wherein the presence of at least one specified feature has a positive impact on the decision and the presence of at least one other specified feature has a negative impact on the decision.

11. The computerized system of claim 1, wherein the absence of at least one specified feature has a positive impact on the decision and the absence of at least one other specified feature has a negative impact on the decision.

12. The computerized system of claim 1, wherein the presence or absence of each specified feature is used to determine a respective scalar value and the scalar values are used to create a multi-dimension vector.

13. The computerized system of claim 12, wherein different weights are given to at least two of the scalar values in the multi-dimension vector.

14. The computerized system of claim 1, wherein the determination is made as a function of the frequency of occurrence of at least one of the specific features.

15. The computerized system of claim 1, wherein the decision is made as a function of the average time it takes to access a page of the merchant website.

16. The computerized system of claim 1, wherein the decision is made as a function of the average time it takes to read each page of the merchant website.

17. The computerized system of claim 1, wherein the decision is made as a function of the number of links on at least one of the pages of the website.

18. The computerized system of claim 1, wherein the decision is also made as a function of information about the merchant website gathered from third party sources.

19. The computerized system of claim 18, wherein the third party sources include one or more third party websites.

20. The computerized system of claim 19, wherein the third party websites include one or more of search engines, social networking sites and review sites.

21. The computerized system of claim 1, wherein the decision is made as a function of the average time it takes to access a page of the merchant website.

22. The computerized system of claim 1, wherein the web pages are crawled by following links located on web pages of the website to other web pages.

23. The computerized system of claim 1, wherein the web pages are crawled by rating the links on one or more of the web pages and then following the links in an order based upon such rating.

24. The computerized system of claim 23, wherein the rating is made as a function of the likelihood that the page identified by such link will contain one or more features of interest.

25. The computerized system of claim 23, wherein only some of the links are followed.

26. The computerized system of claim 24, wherein the crawling process is stopped after a predetermined time period even if not all of the links have been followed.

27. A computer network, comprising:
a customer computer which allows a customer to browse websites offering the sale of goods;
a loan approval computer system programmed to analyse whether or not a loan to the customer should be approved;
the customer computer sending a notification to the loan approval computer system when the customer's computer is browsing a merchant's website which is offering goods for sale; and
in response to the receipt of such notice, the loan approval computer system crawling one or more web pages of the website being browsed by the customer and determining whether or not to approve a loan to the customer as a function of the presence or absence of specified content on at least one page of the website.

28. The computerized system of claim 27, wherein the computerized system also authorizes payment to the merchant in the event the loan is authorized and the customer purchases goods from the website of the merchant.

29. The computerized system of claim 27, wherein the specified features includes the presence or absence of specified words on the pages.

30. The computerized system of claim 29, wherein the specified words provide an indication of whether the website is a website of a reputable merchant.

31. The computerized system of claim 29, wherein the specific words are stored on a configurable list.

32. The computerized system of claim 29, wherein the specific words include one or more of the following phrases: “customer service”, “company history”, “our vision” or “live chat”.

33. The computerized system of claim 27, wherein the specified features include features of the website which provide an indication of whether the website is a website of a reputable merchant.

34. The computerized system of claim 33, wherein the specified features include one or more of the following: a kitemark or a certificate.

35. The computerized system of claim 33, wherein the specified features include the presence of an HTML that closely follows the rules of Extendable Mark Up Language.

36. The computerized system of claim 27, wherein the presence of at least one specified feature has a positive impact on the decision and the presence of at least one other specified feature has a negative impact on the decision.

37. The computerized system of claim 27, wherein the absence of at least one specified feature has a positive impact on the decision and the absence of at least one other specified feature has a negative impact on the decision.

38. The computerized system of claim 37, wherein the presence or absence of each specified feature is used to determine a respective scalar value and the scalar values are used to create a multi-dimension vector.

39. The computerized system of claim 27, wherein different weights are given to at least two of the scalar values in the multi-dimension vector.

40. The computerized system of claim 27, wherein the determination is made as a function of the frequency of occurrence of at least one of the specific features.

41. The computerized system of claim 27, wherein the decision is made as a function of the average time it takes to access a page of the merchant website.

42. The computerized system of claim 27, wherein the decision is made as a function of the average time it takes to read each page of the merchant website.

43. The computerized system of claim 27, wherein the decision is made as a function of the number of links in the web pages.

44. The computerized system of claim 27, wherein the decision is also made as a function of information about the merchant website gathered from third party sources.

45. The computerized system of claim 44, wherein the third party sources include one or more third party websites.

46. The computerized system of claim 45, wherein the third party websites include one or more search engines, social networking sites and review sites.

47. The computerized system of claim 27, wherein the decision is made as a function of the average time it takes to access a page of the merchant website.

48. The computerized system of claim 27, wherein the web pages are crawled by following links located on web pages of the website to other web pages.

49. The computerized system of claim 27, wherein the web pages are crawled by rating the links on one or more of the web pages and then following the links in an order based upon such rating.

50. The computerized system of claim 27, wherein the rating is made as a function of the likelihood that the page identified by such link will contain features of interest.

51. The computerized system of claim 49, wherein only some of the links are followed.

52. The computerized system of claim 51, wherein the crawling process is stopped after a predetermined time period even if not all of the links have been followed.

53. A process for making a decision as to whether to provide a loan to a customer who would like to purchase goods from a website of a merchant, the process being carried out by a computerized system comprising at least one processor, at least one memory and at least one program stored in at least one of the memories, the at least one program causing the computerized system to carry out the process of:
responding to the receipt of a notification that the customer is browsing one or more pages of the website by:
crawling one or more pages of the website to determine the presence or absence of specified features on the pages; and
providing a decision as to whether or not to authorize a loan to the customer to purchase goods from the merchant as a function of the presence or absence of the specified features.

54. The process of claim 53, wherein the computerized system also authorizes payment to the merchant in the event the loan is authorized and the customer purchases goods from the website.

55. The process of claim 53, wherein the specified features includes the presence or absence of specified words on at least one of the web pages of the website.

56. The process of claim 55, wherein the specified words provide an indication of whether the website is a website of a reputable merchant.

57. The process of claim 55, wherein the specific words are stored on a configurable list.

58. The process of claim 55, wherein the specific words include one or more of the following phrases: “customer service”, “company history”, “our vision” or “live chat”.

59. The process of claim 53, wherein the specified features include features of the website which provide an indication of whether the website is a website of a reputable merchant.

60. The process of claim 59, wherein the specified features include one or more of the following: a kitemark or a certificate.

61. The process of claim 59, wherein the specified features include the presence of an HTML that closely follows the rules of Extendable Mark Up Language.

62. The process of claim 53, wherein the presence of at least one specified feature has a positive impact on the decision and the presence of at least one other specified feature has a negative impact on the decision.

63. The process of claim 53, wherein the absence of at least one specified feature has a positive impact on the decision and the absence of at least one other specified feature has a negative impact on the decision.

64. The process of claim 53, wherein the presence or absence of each specified feature is used to determine a respective scalar value and the scalar values are used to create a multi-dimension vector.

65. The process of claim 64, wherein different weights are given to at least two of the scalar values in the multi-dimension vector.

66. The process of claim 53, wherein the determination is made as a function of the frequency of occurrence of at least one of the specific features.

67. The process of claim 53, wherein the decision is made as a function of the average time it takes to access a page of the merchant website.

68. The process of claim 53, wherein the decision is made as a function of the average time it takes to read each page of the merchant website.

69. The process of claim 53, wherein the decision is made as a function of the number of links on at least some of the pages of the website.

70. The process of claim 53, wherein the decision is also made as a function of information about the merchant website gathered from third party sources.

71. The process of claim 70, wherein the third party sources include one or more third party websites.

72. The process of claim 71, wherein the third party websites include one or more of search engines, social networking sites and review sites.

73. The process of claim 53, wherein the decision is made as a function of the average time it takes to access a page of the merchant website.

74. The process of claim 53, wherein the web pages are crawled by following links located on web pages of the website to other web pages.

75. The process of claim 53, wherein the web pages are crawled by rating the links on one or more of the web pages and then following the links in an order based upon such rating.

76. The process of claim 75, wherein the rating is made as a function of the likelihood that the page identified by such link will contain one or more features of interest.

77. The process of claim 75, wherein only some of the links are followed.

78. The process of claim 76, wherein the crawling process is stopped after a predetermined time period even if not all of the links have been followed.

79. A process carried out by computer including a customer computer which allows a customer to browse websites offering the sale of goods, and a loan approval computer system programmed to analyse whether or not a loan to the customer should be approved, the process comprising:
the customer computer sending a notification to the loan approval computer system when the customer's computer is browsing a merchant's website which is offering goods for sale; and
in response to the receipt of such notice, the loan approval computer system crawling one or more web pages of the website being browsed by the customer and determining whether or not to approve a loan to the customer as a function of the presence or absence of specified content on at least one page of the website.

80. The process of claim 79, wherein the computerized system also authorizes payment to the merchant in the event the loan is authorized and the customer purchases goods from the website of the merchant.

81. The process of claim 79, wherein the specified features includes the presence or absence of specified words on the pages.

82. The process of claim 81, wherein the specified words provide an indication of whether the website is a website of a reputable merchant.

83. The process of claim 81, wherein the specific words are stored on a configurable list.

84. The process of claim 81, wherein the specific words include one or more of the following phrases: “customer service”, “company history”, “our vision” or “live chat”.

85. The process of claim 79, wherein the specified features include features of the website which provide an indication of whether the website is a website of a reputable merchant.

86. The process of claim 85, wherein the specified features include one or more of the following: a kitemark or a certificate.

87. The process of claim 85, wherein the specified features include the presence of an HTML that closely follows the rules of Extendable Mark Up Language.

88. The process of claim 79, wherein the presence of at least one specified feature has a positive impact on the decision and the presence of at least one other specified feature has a negative impact on the decision.

89. The process of claim 79, wherein the absence of at least one specified feature has a positive impact on the decision and the absence of at least one other specified feature has a negative impact on the decision.

90. The process of claim 89, wherein the presence or absence of each specified feature is used to determine a respective scalar value and the scalar values are used to create a multi-dimension vector.

91. The process of claim 79, wherein different weights are given to at least two of the scalar values in the multi-dimension vector.

92. The process of claim 79, wherein the determination is made as a function of the frequency of occurrence of at least one of the specific features.

93. The process of claim 79, wherein the decision is made as a function of the average time it takes to access a page of the merchant website.

94. The process of claim 79, wherein the decision is made as a function of the average time it takes to read each page of the merchant website.

95. The process of claim 79, wherein the decision is made as a function of the number of links in the web pages.

96. The process of claim 79, wherein the decision is also made as a function of information about the merchant website gathered from third party sources.

97. The process of claim 96, wherein the third party sources include one or more third party websites.

98. The process of claim 97, wherein the third party websites include one or more search engines, social networking sites and review sites.

99. The process of claim 79, wherein the decision is made as a function of the average time it takes to access a page of the merchant website.

100. The process of claim 79, wherein the web pages are crawled by following links located on web pages of the website to other web pages.

101. The process of claim 79, wherein the web pages are crawled by rating the links on one or more of the web pages and then following the links in an order based upon such rating.

102. The process of claim 79, wherein the rating is made as a function of the likelihood that the page identified by such link will contain features of interest.

103. The process of claim 101, wherein only some of the links are followed.

104. The process of claim 103, wherein the crawling process is stopped after a predetermined time period even if not all of the links have been followed.
